(19) United States
(12) Patent Application Publication
(10) Pub. No.: US 2026/0120186 A1
(43) Pub. Date: Apr. 30, 2026

(54) System And Method For Determining Stock Trading Fees

(71) Applicant: THE PEOPLES’ INSTITUTE FOR THE ENLIGHTENMENT OF SOCIETY, INC, Ann Arbor, MI (US)

(72) Inventor: Charles Kritzmacher, Ann Arbor, MI (US)

(73) Assignee: THE PEOPLES’ INSTITUTE FOR THE ENLIGHTENMENT OF SOCIETY, INC, Ann Arbor, MI (US)

(21) Appl. No.: 19/375,357

(22) Filed: Oct. 31, 2025

Related U.S. Application Data
(60) Provisional application No. 63/714,259, filed on Oct. 31, 2024.

(51) Int. Cl. G06Q 40/04

(52) U.S. Cl. CPC G06Q 40/04

(57) ABSTRACT

A system for determining a securities trading fee for a transaction includes a processor configured to acquire a trading history for a party to the transaction, wherein the trading history describes historical transactions in which the party participated and identify an indicative variable including a valuation variable for each of the historical transactions or a time variable for each of the historical transactions. The processor is configured to determine the fee for the party for the transaction based upon the indicative variable corresponding to each of the historical transactions. Determining the fee includes charging increasing fees for relatively smaller values of the time variable of historical transactions or charging increasing fees when the historical transactions include relatively larger valuation variable values and generate an output based upon the fee.

### CROSS-REFERENCE TO RELATED APPLICATIONS

The subject patent application claims priority to, and all the benefits of, U.S. Provisional Patent Application No. 63/714,259, filed on Oct. 31, 2024, the entire contents of which are incorporated by reference herein.

### TECHNICAL FIELD

The present invention relates to financial transactions, and more particularly, to a computerized system and method for determining stock trading fees for sale and purchase transactions.

### BACKGROUND

A security may be defined as any of a wide array of investments, such as stocks, bonds, notes, debentures, limited partnership interests, oil and gas interests, and investment contracts. A securities exchange is a marketplace where securities are bought and sold. The term “exchange” means any organization, association, or group of persons, whether incorporated or unincorporated, which constitutes, maintains, or provides a marketplace or facilities for bringing together purchasers and sellers of securities or for otherwise performing with respect to securities the functions commonly performed by a stock exchange as that term is generally understood and includes the marketplace and the market facilities maintained by such exchange.

The term “broker” means any person engaged in the business of effecting transactions in securities for the account of others.

### SUMMARY

Investing is performed by persons, companies, institutions, or other entities buying securities. One may buy a security, hold the security for a time period while the investment appreciates in value, and realize a financial gain by selling the security at a higher price than at which it was bought. An exemplary company seeks to operate at a profit which tends to cause valuation of the company to increase over time. Such an increase in valuation may result in a stock price of the company to increase. The company may pay a dividend to shareholders, further increasing a likelihood that the stock price of the company will increase. Bond or debt related investments yield returns based upon an interest rate at which the underlying principal amount was borrowed. Regular or period purchases of investments over time may result in an accrual of wealth. As conditions change, an individual or entity may experience changed priorities. The financial health of a particular company and the resulting likelihood that its stock price will increase may change. Interest rates may change, and the value of a particular good or value anticipated future value of that good may change over time. Buying and selling securities over a relatively long period of time with reasonable transactional costs is foundational to a free market economy.

Security trading practices may alternatively include short-term and/or high-volume transactions that distort the market. Day-trading practices may involve moving in and out of securities multiple times in a single day. A hedge fund may trade a security on large volume over a brief period of time to manipulate or force responses from blocks of investors. Market manipulation describes a variety of securities trading practices designed to deceive investors by controlling or artificially affecting the price of securities.

In the field of operating a securities exchange, determining appropriate fees for transactions is useful and facilitates long-term growth and trust in the market. Traditional methods to determine fees may focus on rewarding large trades and frequent trading practices, which may be beneficial for large investment firms that wish to have an advantage over smaller, less-frequently trading investors. Such traditional methods, promoting large volume trading to the benefit of larger firms, may lead to higher profits at those larger firms but may simultaneously lead to larger market inefficiencies, reduced profits for the smaller traders, and may lead to the general public mistrusting the trading markets as being fixed, rigged, or unfair. There is a need for a more sophisticated system that can dynamically determine trading fees based on historical data and specific transaction variables.

A system for determining a securities trading fee for a sale and purchase transaction is provided. The system includes one or more computerized processors configured to acquire a trading history for a party to the sale and purchase transaction, wherein the trading history describes a plurality of historical sale and purchase transactions in which the party participated and identify an indicative variable including a valuation variable for each of the plurality of historical sale and purchase transactions or a time variable for each of the plurality of historical sale and purchase transactions. The processors are further configured to determine the securities trading fee for the party for the sale and purchase transaction based upon the indicative variable corresponding to each of the plurality of historical sale and purchase transactions, wherein determining the securities trading fee includes charging increasing fees for relatively smaller values of the time variable of the plurality of historical sale and purchase transactions or charging increasing fees when the plurality of historical sale and purchase transactions include relatively larger valuation variable values and generate an output based upon the securities trading fee.

According to one alternative embodiment, a system for determining a securities trading fee for a sale and purchase transaction is provided. The system includes one or more computerized processors configured to acquire a first trading history for a buyer of the sale and purchase transaction, wherein the first trading history describes a plurality of historical sale and purchase transactions in which the buyer participated, identify for the buyer of the sale and purchase transaction a valuation variable for each of the plurality of historical sale and purchase transactions in which the buyer participated, and identify for the buyer of the sale and purchase transaction a time variable for each of the plurality of historical sale and purchase transactions in which the buyer participated. The processors are further configured to acquire a second trading history for a seller of the sale and purchase transaction, wherein the second trading history describes a plurality of historical sale and purchase transactions in which the seller participated, identify for the seller of the sale and purchase transaction a valuation variable for each of the plurality of historical sale and purchase transactions in which the seller participated, and identify for the seller of the sale and purchase transaction a time variable for each of the plurality of historical sale and purchase transactions in which the seller participated. The processors are further configured to assess an impact to the buyer of a presently desired transaction and assess an impact to the seller of the presently desired transaction. The processors are further configured to determine the securities trading fee for the buyer to the sale and purchase transaction for the sale and purchase transaction based upon the valuation variable and the time variable corresponding to each of the plurality of historical sale and purchase transactions in which the buyer participated and the assessed impact to the buyer, determine the securities trading fee for the seller to the sale and purchase transaction for the sale and purchase transaction based upon the valuation variable and the time variable corresponding to each of the plurality of historical sale and purchase transactions in which the seller participated and the assessed impact to the seller, and generate an output based upon the securities trading fees.

According to another alternative embodiment, a method for determining a securities trading fee for a sale and purchase transaction is provided. The method includes, within one or more computerized processors, acquiring a first trading history for a buyer of the sale and purchase transaction, wherein the first trading history describes a plurality of historical sale and purchase transactions in which the buyer participated, identifying for the buyer of the sale and purchase transaction a valuation variable for each of the plurality of historical sale and purchase transactions in which the buyer participated, and identifying for the buyer of the sale and purchase transaction a time variable for each of the plurality of historical sale and purchase transactions in which the buyer participated. The method further includes, within the one or more processors, acquiring a second trading history for a seller of the sale and purchase transaction, wherein the second trading history describes a plurality of historical sale and purchase transactions in which the seller participated, identifying for the seller of the sale and purchase transaction a valuation variable for each of the plurality of historical sale and purchase transactions in which the seller participated, and identifying for the seller of the sale and purchase transaction a time variable for each of the plurality of historical sale and purchase transactions in which the seller participated. The method further includes, within the one or more processors, determining the securities trading fee for the buyer to the sale and purchase transaction for the sale and purchase transaction based upon the valuation variable and the time variable corresponding to each of the plurality of historical sale and purchase transactions in which the buyer participated. The method further includes, within the one or more processors, determining the securities trading fee for the seller to the sale and purchase transaction for the sale and purchase transaction based upon the valuation variable and the time variable corresponding to each of the plurality of historical sale and purchase transactions in which the seller participated. The method further includes generating an output based upon the securities trading fees.

In some embodiments, the one or more computerized processors are further configured to acquire a trading history for each of a plurality of parties to the sale and purchase transaction, identify for each of the plurality of parties to the sale and purchase transaction an indicative variable including the valuation variable for each of the plurality of historical sale and purchase transactions or the time variable for each of the plurality of historical sale and purchase transactions, determine the securities trading fee for each of the plurality of parties to the sale and purchase transaction for the sale and purchase transaction based upon the indicative variable corresponding to each of the plurality of historical sale and purchase transactions, and generate an output based upon the securities trading fees.

In some embodiments, the one or more computerized processors are further configured to identify the valuation variable for each of the plurality of historical sale and purchase transactions, identify the time variable for each of the plurality of historical sale and purchase transactions, and determine the securities trading fee for the party for the sale and purchase transaction based upon the valuation variable and the time variable corresponding to each of the plurality of historical sale and purchase transactions.

In some embodiments, the one or more computerized processors are further configured to acquire a trading history for each of a plurality of parties to the sale and purchase transaction, wherein the trading history describes a plurality of historical sale and purchase transactions in which the party participated, identify for each of the plurality of parties to the sale and purchase transaction a valuation variable for each of the plurality of historical sale and purchase transactions. The processor(s) are further configured to identify a time variable for each of the plurality of historical sale and purchase transactions, determine the securities trading fee for each of the plurality of parties to the sale and purchase transaction for the sale and purchase transaction based upon the valuation variable and the time variable corresponding to each of the plurality of historical sale and purchase transactions, and generate an output based upon the securities trading fees.

In some embodiments, the one or more computerized processors being configured to determine the securities trading fees for the party for the sale and purchase transaction includes the one or more computerized processors being configured to determine a trading score for the party.

In some embodiments, the one or more computerized processors being configured to determine the trading score for the party includes the one or more computerized processors being configured to assess the valuation value and penalize the score based upon the valuation value indicating high value trades in excess of a threshold valuation.

In some embodiments, the one or more computerized processors being configured to determine the trading score for the party includes the one or more computerized processors being configured to assess the time value and penalize the score based upon the time value indicating a time between trades being less than a threshold time.

In some embodiments, the one or more computerized processors being configured to determine the trading score includes a time decay effect lessening an effect upon the score of older portions of the trading history.

In some embodiments, the one or more computerized processors being configured to determine the trading score includes the one or more computerized processors being configured to penalize the score based upon the trading history indicating an undesirable trading pattern indicating market manipulation.

In some embodiments, the one or more computerized processors being configured to penalize the score based upon the trading history indicating an undesirable trading pattern indicating market manipulation includes the one or more computerized processors being configured to penalize the score based upon the trading history indicating a short squeeze or spoofing.

In some embodiments, the one or more computerized processors being configured to generate the output based upon the securities trading fee includes the one or more computerized processors being configured to publish the securities trading fee to the party and prompt the party to approve the sale and purchase transaction.

In some embodiments, the one or more computerized processors is further configured to execute the sale and purchase transaction based upon approval of the party.

In some embodiments, generating the output includes charging the securities trading fees to the buyer and to the seller.

In some embodiments, generating the output further includes executing the sale and purchase transaction.

In some embodiments, generating the output includes discharging funds deposited as execution of the sale and purchase transaction.

In some embodiments, generating the output includes publishing accumulated statistics for a plurality of sale and purchase transactions to validate equitable purposes of the method.

### BRIEF DESCRIPTION OF THE DRAWINGS

The present disclosure will become more fully understood from the detailed description and the accompanying drawings.

FIG. 1 schematically illustrates a system for determining a securities trading fee for a sale and purchase transaction, in accordance with the present disclosure.

FIG. 2 schematically illustrates the securities exchange server of FIG. 1, in accordance with the present disclosure.

FIG. 3 is a flowchart illustrating an exemplary method to determine trading fees for a pending transaction and subsequently execute the transaction, in accordance with the present disclosure.

FIG. 4 is a flowchart illustrating an exemplary method to execute a trade for a seller in a sale and purchase transaction, in accordance with the present disclosure.

FIG. 5 is a flowchart illustrating an exemplary method to execute a trade for a buyer in a sale and purchase transaction, in accordance with the present disclosure.

FIG. 6 is a flowchart illustrating a method for determining trade details including trade fees for both a buyer and a seller to a transaction, confirming approval of both the buyer and the seller, and executing the pending transaction, in accordance with the present disclosure.

FIG. 7 is a flowchart illustrating an exemplary method to classify a party to a transaction into a defined fee group based upon a trading history of the party, in accordance with the present disclosure.

FIG. 8 is a flowchart illustrating an exemplary method to access a trading history for one of the parties to a transaction including assessment of an effect of a presently requested transaction, in accordance with the present disclosure.

FIG. 9 is a table illustrating exemplary results of slow and steady saving scenarios in relation to the disclosed methods, in accordance with the present disclosure.

FIG. 10 is a table illustrating exemplary milestone withdrawal scenarios in relation to the disclosed methods, in accordance with the present disclosure.

FIG. 11 is a table illustrating exemplary results of long-term investing scenarios in relation to the disclosed methods, in accordance with the present disclosure.

FIG. 12 is a table illustrating exemplary anomalous scenarios in relation to the disclosed methods, in accordance with the present disclosure.

FIG. 13 is a table illustrating exemplary results of institutional long-term investing scenarios in relation to the disclosed methods, in accordance with the present disclosure.

FIG. 14 is a table illustrating exemplary market correction scenarios in relation to the disclosed methods, in accordance with the present disclosure.

FIG. 15 is a table illustrating exemplary results of day-trading scenarios in relation to the disclosed methods, in accordance with the present disclosure.

FIG. 16 is a table illustrating exemplary results of jackpot scenarios in relation to the disclosed methods, in accordance with the present disclosure.

FIG. 17 is a table illustrating exemplary results of scheduled divestment scenarios in relation to the disclosed methods, in accordance with the present disclosure.

FIG. 18 is a table illustrating exemplary results of rapid divestment scenarios in relation to the disclosed methods, in accordance with the present disclosure.

### DETAILED DESCRIPTION

The PIES Economy™ is a security trading and ownership system developed by the The Peoples' Institute for the Enlightenment of Society, Inc. of Ann Arbor, Michigan and includes methods and processes useful to register securities, their holders, and the individual rights afforded by each to each respectively.

The official registry of securities may provide the necessary information to express securityholders' rights. The primary purpose of any registry is to serve as the source of truth for ownership rights. The primary purpose for this method of registering securities is to enact economic justice amongst the securityholders. Whereas most registries express securityholders' rights as essentially proportionate to their holdings, our registry augments or suppresses the relative rights of the securities being held based on characteristics about those respective securities which are dependent on time and the distribution of assets across the registry.

In one implementation, methods and processes may be provided to better distribute equity equitably so that securityholders utilizing and owning property through the PIES Economy™ may have representation, through ownership, in the governing of the PIES Economy™. Representation in governing business is crucial to economic justice. Through representation, individuals can direct businesses to protect their health and the environment, give them living wages, reform modern work-life balance, and much more. A co-pending and co-owned patent application titled “Method and System for Modulating the Rights of an Owner of a Security” in U.S. patent application Ser. No. 19/311,573 filed on Aug. 27, 2025, is hereby incorporated by reference.

In furtherance of these goals, a system and method that fosters a thriving economic environment for both investors and issuers is provided. The method facilitates economic stability by encouraging and rewarding long-term ownership and patient investing. The method gives a greater voice to those who are more invested in the long-run, lending additional stability to participating businesses. Stability is paramount to a thriving economy and to a sustainable business model. Ethical businesses with sustainable business models usually out-perform and out-survive their short-sighted competitors.

This method thereby achieves many desirable effects for the members of the PIES Economy™, and it does so through economic incentives. A mechanism for encouraging excellent trading practices is useful to providing a fair and equitable market in which investors and the public may have confidence and transparency. A system and method for operating a computerized securities exchange is provided, wherein a trading history of one or each of the trading parties may be utilized to set a fee or fees for the transaction. Trading history may include an element related to a size of the historical transactions, for example, a valuation factor configured to provide elevated fees in response to a history of high value trades. The valuation factor may include looking at total valuation of each transaction, a number of shares involved in the transaction, a total percentage of a company's shares involved in the transaction, or other similar metrics. Trading history may further or alternatively include an element related to time, for example, a time factor configured to provide elevated fees in response to a history of frequent trading. The time factor may include determining a time weighting value for a previous transaction based upon how long ago the transaction took place, determining a time since a previous transaction was executed, a measure of how many transactions were initiated in a time span, or other similar metrics.

The disclosed method and system may include operation of a trading exchange wherein securities are traded from a seller to a buyer. Examples of trading exchanges operated in the United States include the New York Stock Exchange (NYSE), the Nasdaq, and the Chicago Mercantile Exchange. The disclosed system and method may share some characteristics with such exchanges, matching offers from the buyers and the sellers and executing acceptable trades on a first come, first served basis. Trades may be selected for execution based upon matching similar prices, executing as large of share block trades as possible, maximizing the value of the shares involved in a particular trade.

According to one example of how the method may operate includes a first step where a buyer and a seller for the proposed trade transaction are identified. A trading fee for one of the parties or a plurality of trading fees for each of the parties are determined for a pending transaction. This fee is determined based upon a trading history of the party involved. If the party is a relatively infrequent trader and the valuation of the historical trades is relatively low, the determined trading fee will be relatively low or a minimum value. If the party is a relatively frequent trader while the valuation of the historical trades is relatively low, the fee may be elevated above a minimum value but not at a maximum value. If the party is a relatively infrequent trader while the valuation of the historical trades is relatively high, the fee may be elevated above a minimum value but not at a maximum value. If the party is a relatively frequent trader while the valuation of the historical trades is relatively high, the fee may be elevated to a highest or a maximum value.

Trading history may include trades that were performed through the exchange, i.e., the disclosed system, with the details of the trades being saved in memory of the system. Trading history may additionally take into account other transactions, for example, transfers that occur as a change of recorded ownership without a purchase and sale transaction such as a gift between family members and transfers that occur as a result of a will or a contract. Transfer history may include a transfer that automatically occurs without interaction from the party, such as an automated reinvestment of a dividend.

A trading score may be determined and/or assigned to a party as part of determining the fees to be charged for the pending transaction. The trading score may be calculated or determined based upon an indicative variable selected from one of the valuation factor or the time factor. The trading score may be calculated or determined based upon both the valuation factor and the time factor. In one embodiment, each of a plurality of historical trades may be individually scored based upon the valuation factor and the time factor, and an aggregate or composite score may be determined based upon a totality of the historical trades. The trading history of a party may extend to an entirety of transactions that the party has performed. In another embodiment, the history of the party may extend through a limited or fixed time period, for example, for six months or a year prior to the current determination. In one embodiment, the time factor may include a time weighted feature, for example, accruing a higher fee for more recent trades and accruing lessor fees for trades performed longer ago. Evaluation of the trading history of the party may further include taking into account the currently requested transaction.

The disclosed scoring system may take into account a party type. For example, an individual may be assigned one party type factor, and an institution that handles investments may be assigned a second party type factor. The party type factor may take into account a valuation and a frequency that would be indicative of normal or non-manipulative behavior for that type of party. In this way, an individual may be rewarded or incentivized with relatively lower transaction fees by trading in accordance with provided expectations related to an individual, and an organization that, for instance, handles retirement investments for a company or a labor union may similarly be rewarded or incentivized with relatively lower transaction fees by trading in accordance with provided expectations related to such an organization. While the organization may make more frequent and higher value transactions than the individual, both may be assessed relatively lower or minimum fees as both are conducting transactions that are not indicative of market manipulation.

A weight of a particular previous transaction or a poor behavior penalty may be assessed upon a party for particularly discouraged behavior. For example, trading patterns may indicate that a party was participating in market manipulation, for example, embodied as a short squeeze, short-term buying of security targeted at forcing short sellers to buy the stock to cover their short positions, or spoofing, placing orders and cancelling them prior to the trade execution to create a false impression of high demand for the security. The disclosed method may assess a score for the trader involved based upon the value and time span in which the transaction or transactions occurred, and may further impact the score by imposing a penalty upon the score for undertaking behavior indicative of manipulation.

The disclosed system and method enable ethical business practices and valuable missions that serve the public interest. The disclosed system and method utilize determinations based upon exemplary algorithms to inhibit behaviors including market manipulation and short-sighted greed, enable long-term thinking and strategy, and provide continuous funding to worthwhile investments.

Trading fees are a primary measure of control on the exchange. The trading fees may be configured to prevent excessive sell-off and buy-out. The trading fees may be useful to deter day-trading or trading practices that include rapid, short-term positions in securities configured to take advantage of intra-day fluctuations of securities prices.

Trading fees may be determined according to a number of methods. In a first example of a method to determine trading fees, each of the buyer and the seller may receive a trading score based upon a time factor and a valuation factor, each describing historical trades made by the party. This trading score is then used to modify a base or minimum fee. In one such example, the score may yield a fee factor between 1 and 5, a base fee may be identified to include a fixed amount, a fixed amount per share, or a percentage of the value of the securities being traded. The final fee charged to the party may be the fee factor times the base fee.

In another example of a method to determine trading fees, parties trading on the exchange may be placed into groups based upon trading history behavior. For example, traders that practice typical, orderly trading practices may be placed into a first group with a lowest trading fee. Traders that have a limited history of unfavorable trading practices, for example, exceeding a threshold number of trades in a period of time or exceeding a threshold value of securities traded may be placed into a second group with a medium trading fee. Traders with an established pattern of unfavorable trading practices may be placed into a third group with a highest trading fee. Such groupings of traders may be useful to motivate behavior, for example, deterring traders from undertaking certain transactions to avoid being moved to a higher fee group. The securities exchange may publish to the trader their group classification and may provide information such as “The trade you are about to authorize will cause you to move from group two to group three and will incur higher trading fees from this point forward. Do you wish to proceed?” Another trader may receive a publication from the exchange for trading behaviors that may aid them in moving from the second trading group to the first trading group.

An imposition of higher trading fees based upon historical trading information for a trading party may be imposed upon the party regardless of the nature of the present transaction that is being authorized. In another embodiment, a party with a history of unfavorable trading practices may be placed on probation for higher fees, for example, with a new trade order with a reasonable time factor and valuation factor still being charged at a lower trading fee but with new orders with a time factor and/or a valuation factor exceeding a threshold, the trader may be charged at a penalized higher trading fee.

Methods and systems described herein may be said to foster or create an equitable trading system, wherein the inherent financial power and trading expertise of massive trading entities is counterbalanced with the rights of the smaller, less-professional traders. This counterbalance, this normalization of the market may be said to equalize, normalize, or bring into balance the benefits of the system for all parties to take equal or equivalent part in. One may describe the methods and systems as taking in account economic externalities inherent in a trading system wherein large traders with close knowledge of the market get unfair or unusual access to the benefits and profits of the trading system.

### Exemplary Trade Fee Calculations

Trading fees in accordance with the disclosed method and system may take many forms. The following provides one non-limiting example of calculations that may be utilized in such a method and system. Other calculations are envisioned, and the disclosure is not intended to be limited to the examples provided herein.

### Trade Score

A trade score may be determined based upon the historical transactions of a buyer or seller. Trade score may be used, once determined, to set the transaction fee of the buyer or seller. The trading score may be calculated or determined based upon one of the valuation factor or the time factor. The trading score may be calculated or determined based upon both the valuation factor and the time factor. The following provides one example of how the trading score may be determined and utilized. The trading score may additionally take into account the current trade being requested. Other trading scores may be utilized, and the disclosure is not intended to be limited to the embodiments provided as examples herein.

A trade score may be useful to provide a quantification of the frequency and volume of trading being conducted by an individual. In one exemplary determination, every historical trade generates a trade score which will decay exponentially with respect to time. Equation 1 provides an exemplary determination of a trade score for one historical transaction.

$$Trade Sc {ore}_{n} ( t ) = TSPI \times {e}^{\frac{t - {t}_{n}}{T}} \times ( {TV}_{n} + K ) \qquad ( 1 )$$

Wherein:
TSPI=Trade Score Price Index
t=Date/Time of Trade Score Determination
tₙ=Date/Time of Historical Trade n Transaction
T=Time Constant in Days
TVₙ=Value of Historical Trade n
K=Constant Signifying “Additional” Trade Score

TSPI and K may be selected based upon desirable/equitable/cost-based/market-based values regarding how much the resulting trading fees should be at various portions of the resulting trade score output curve. The value of trade n is determined at the time of the trade. The two parties making the trade will have made trade offerings to buy or sell based on specific valuations of the security being traded.

When trade offers are matched up, they may, in one embodiment, be executed at a valuation equal to the average of the two offers. Therefore, the following expression defined as Equation 2 may be used to evaluate value of trade n.

$$T {V}_{n} = \frac{Securities being traded}{Total of securities available} \times \frac{\begin{matrix}Buyer valuation of total of securities available + \\ Seller valuation of the total of securities available\end{matrix}}{2} \qquad ( 2 )$$

### Trade Fees

When such a trade is executed, both the buyer and the seller will pay fees in accordance with a fee determination. In one example, each party's total trade score at the time of this new trade will be used to determine their respective trade fees. The trade fee for each individual participating in each trade is then calculated as a percentage of the value of the securities being traded. This is achieved using the following expression which is defined as Equation 3.

$$Trade {Fee}_{N} = Trade Fee {Percentage}_{N} ( t ) \times T {V}_{N} \qquad ( 3 )$$

Trade Fee Percentage_{N} is the fee percentage represented by a complex expression that resembles an S-curve, as described by Equation 4.

$$Trade Fee {Percentage}_{N} = M \times \frac{1}{2} ( 1 - cos ( ( K 2 - \frac{K 1}{K 3 + Total Trade {Score}_{N} {( t )}^{K 4}} ) π ) ) \qquad ( 4 )$$

Wherein:
M=Percentage Maximum or a Maximum Trade Fee Percentage Permitted
K₁=Constant 1
K₂=Constant 2
K₃=Constant 3
K₄=Constant 4

The historical trade scores determined at present time t_{N}, Trade Scoreₙ (t), are each time weighted. More recent transactions affect the present trade score more than older transactions—the scores deteriorate or have less weight over time. The instantaneous total trade score of any individual at any given time is calculated as the sum of the historical trade scores, as described by Equations 5 and 6.

$$Total Trade {Score}_{n} ( t ) = {\sum }_{1}^{N} Trade {Score}_{n} ( t ) \qquad ( 5 )$$

$$Total Trade {Score}_{n} ( t ) = {\sum }_{1}^{N} TSPI \times {e}^{\frac{t - {t}_{n}}{T}} \times {TV}_{n} \qquad ( 6 )$$

Wherein n=1 represents the individual's first ever trade, and n=N represents the most recent trade at date/time t.

As trade score goes to infinity, the cosine reaches an asymptote. The constants drive that asymptote to be equal to M, which is expressed as a percentage of the trade. These calibrations shall be defined by economic markers, and with the intention of driving equity, ethics, and general societal wellbeing.

When a trade is executed, the seller's securities named in the transaction are transferred to the buyer, and the buyer's escrow funds are transferred to the seller, with fees being applied to each individual. The seller's total proceeds will be equal to the value of the securities being sold minus the seller's trade fee, expressed as follows by Equation 7.

$${PT}_{N} = {TV}_{N} - Trade Fee = {TV}_{N} - {TFP}_{N} \times {TV}_{N} = {TV}_{N} \times ( 1 - {TFP}_{N} ) \qquad ( 7 )$$

The buyer will transact the value of the securities being bought, plus the buyer's trade fee. Consequently, the buyer's transaction total, defined as Equation 8, may be expressed as follows.

$$T {T}_{N} = T {V}_{N} + Trade Fee = {TV}_{N} + {TFP}_{N} \times {TV}_{N} = {TV}_{N} \times ( 1 + {TFP}_{N} ) \qquad ( 8 )$$

### Buying Power

In order to broker trades between buyers and sellers, one may calculate the buying power of any given purchase offer. Expressed differently, when a purchase offer is evaluated for matching sale offers, TT_{N} is known, but TV_{N} is unknown. This is because purchase offers are constructed by staking a fixed amount of funds in escrow to enable purchases at the specified valuation. However, their purchasing power is affected by their total trade score, which changes with time. The total trade score for the buyer has to be evaluated at the time that a trade is matched and executed.

### Basic Limits

When given a transaction total for a purchase order (i.e. the staked funds in escrow), the purchasing power can be approximated by calculating the limits of the Trade Value of Trade N. To start, we know the following about the Trade Value of any given Trade n: 0≤TVₙ≤TTₙ. This follows from the trade fee percentage being a positive number: 0≤Trade Fee Percentage(t)≤M. Given that M is initially set to 1, one may know that: 0≤M≤1. Further, one may know that: TT_{N}=TV_{N}×(1+TFP_{N}). One may rearrange to isolate TV_{N}, as define by Equation 9 as follows.

$${TV}_{N} = {TT}_{N} ( 1 + {TFP}_{N} ) \qquad ( 9 )$$

The following limits are therefore known for a known TT_{N}: TV_{Nmax}=TT_{N},

$$TVNmin = \frac{T {T}_{N}}{2} .$$

A minimum possible buying power is given as TV_{Nmin}, and a maximum possible buying power is given as TV_{Nmax}.

### Re-Substituting Limits

With the foregoing, one may determine the buying power of the buyer's offer. Given Equation 9, one may substitute the full expression for the trade fee percentage of the present transaction, TFP_{N}, which is evaluated for trade N at time t_{N}, as defined by Equation 10 as follows.

$${TFP}_{N} = M \times \frac{1}{2} ( 1 - cos ( ( {K}_{2} - \frac{{K}_{1}}{{K}_{3} + Total Trade {Score}_{N} {( t )}^{K 4}} ) π ) ) \qquad ( 10 )$$

Which yields Equation 11 as follows.

$$T {V}_{N} = \frac{{TT}_{N}}{( 1 + M \times \frac{1}{2} ( 1 - cos ( ( {K}_{2} - \frac{{K}_{1}}{{K}_{3} + Total Trade {{Score}_{N} ( t )}^{{K}_{4}}} ) π ) ) )} \qquad ( 11 )$$

Now we turn our attention to evaluating Total Trade Score_{N}(t_{N}), which we can rewrite to isolate the present trade to be made, as described in Equation 12 as follows.

$$Total Trade {Score}_{N} ( {t}_{N} ) = {\sum }_{1}^{N - 1} Trade {Score}_{n} ( {t}_{N} ) + Trade {Score}_{N} ( {t}_{N} ) \qquad ( 12 )$$

One may further expand by evaluating Trade Score_{N}(t_{N}) through Equations 13-16, as follows.

$$Trade {Score}_{N} ( {t}_{N} ) = TSPI \times e \frac{{t}_{N} - {t}_{N}}{T} \times ( T {V}_{N} + K ) \qquad ( 13 )$$

$$Trade {Score}_{N} ( {t}_{N} ) = TSPI \times {e}^{- \frac{o}{T}} \times ( {TV}_{N} + K ) \qquad ( 14 )$$

$$Trade {Score}_{N} ( {t}_{N} ) = TSPI \times {e}^{0} \times ( {TV}_{N} + K ) \qquad ( 15 )$$

$$Trade {Score}_{N} ( {t}_{N} ) = TSPI \times ( {TV}_{N} + K ) \qquad ( 16 )$$

Trade Score_{N} represents the instantaneous impact of the presently determined trade. All historical trades/trade scores would constitute the remainder of the total trade score, but with the time decay factoring in.

One may rewrite the expression for the buyer's total trade score to isolate TVₙ as described in Equation 17, as follows.

$$Total Trade {Score}_{N} ( {t}_{N} ) = {\sum }_{1}^{N - 1} Trade {Score}_{n} ( {t}_{n} ) + TSPI \times ( {TV}_{N} + K ) \qquad ( 17 )$$

Because the buyer's previous trades have all been executed, their associated values may be calculated precisely with equations outlined previously. Therefore, the right side of Equation 17 may be expressed as a constant as described in Equation 18, as follows.

$$Total Trade {Score}_{N} ( {t}_{N} ) = {TS}_{N - 1} + TSPI \times ( {TV}_{N} + K ) \qquad ( 18 )$$

Wherein we define the constant TS_{N-1} as described in Equation 19, as follows.

$${TS}_{N - 1} = {\sum }_{1}^{N - 1} Trade {Score}_{n} ( {t}_{n} ) \qquad ( 19 )$$

One may substitute our expansion of the Total Trade ScoreN(tN) into the expression of TV_{N} as described in Equation 20, as follows.

$$T {V}_{N} = \frac{T {T}_{N}}{( 1 + M \times \frac{1}{2} ( 1 - cos ( ( {K}_{2} - \frac{{K}_{1}}{{K}_{3} + {( {TS}_{N - 1} + TSPI \times ( {TV}_{N} + K ) )}^{{K}_{4}}} ) π ) ) )} \qquad ( 20 )$$

Applying the limits for the value of the present trade, TV_{N}, given a known TT_{N}: TV_{N}_{ₘₐₓ}=TT_{N};

$$T {V}_{{N}_{min}} = \frac{{TT}_{N}}{2} ,$$

one may approximate the buying power by referring to the basic limits that we found before. Substituting these limits into Equation 20, one may express TV_{N}_{ₘₐₓ}, the maximum possible buying power, as follows in Equation 21 and TV_{N}_{ₘᵢₙ}, the minimum possible buying power, as follows in Equation 22.

$$T {V}_{{N}_{max}} = \frac{T {T}_{N}}{( 1 + M \times \frac{1}{2} ( 1 - cos ( ( {K}_{2} \frac{{K}_{1}}{{K}_{3} + {( {TS}_{N - 1} + TSPI \times ( \frac{T {T}_{N}}{2} + K ) )}^{{K}_{4}}} ) π ) ) )} \qquad ( 21 )$$

$$T {V}_{{N}_{min}} = \frac{T {T}_{N}}{( 1 + M \times \frac{1}{2} ( 1 - cos ( ( {K}_{2} - \frac{{K}_{1}}{{K}_{3} + {( T {S}_{N - 1} + TSPI \times ( T {T}_{N} + K ) )}^{{K}_{4}}} ) π ) ) )} \qquad ( 22 )$$

### Linear Interpolation

One may require a precise calculation of TV_{N}. Equation 20 provides a quasi-isolated expression for TV_{N}. By rearranging to isolate TTN, one may derive Equation 23 as follows.

$$T {T}_{N} = T {V}_{N} \times ( 1 + M \times \frac{1}{2} ( 1 - cos ( ( {K}_{2} - \frac{{K}_{1}}{{K}_{3} + {( T {S}_{N - 1} + TSPI \times ( T {V}_{N} + K ) )}^{{K}_{4}}} ) π ) ) ) \qquad ( 23 )$$

Through Equation 23, one may observe that for small changes in TV_{N}, the relationship between TT_{N} and TV_{N} is approximately linear. Therefore, if a value derived from the expression, TV_{N}_{ₘₐₓ}−TV_{N}_{ₘᵢₙ}, is sufficiently small, one may linearly interpolate to find the TV_{N} associated with TT_{N}, as expressed by Equation 24.

$$T {V}_{{N}_{Int}} \approx T {V}_{{N}_{min}} + \frac{T {V}_{{N}_{max}} - T {V}_{{N}_{min}}}{T {T}_{T {V}_{{N}_{max}}} - T {T}_{T {V}_{{N}_{min}}}} \times \frac{{TT}_{N} - {TT}_{{TV}_{{N}_{min}}}}{T {T}_{T {V}_{{N}_{max}}} - {TT}_{{TV}_{{N}_{min}}}} \qquad ( 24 )$$

### Wherein:

$$T {T}_{T {V}_{{N}_{max}}} = T {V}_{{N}_{max}} ( 1 + M \times \frac{1}{2} ( 1 - cos ( ( {K}_{2} - \frac{{K}_{1}}{{K}_{3} + {( {TS}_{N - 1} + TSPI \times ( {TV}_{{N}_{max}} + K ) )}^{{K}_{4}}} ) π ) ) ) \qquad ( 25 )$$

$$T {T}_{T {V}_{{N}_{min}}} = T {V}_{{N}_{min}} ( 1 + M \times \frac{1}{2} ( 1 - cos ( ( {K}_{2} - \frac{{K}_{1}}{{K}_{3} + {( T {S}_{N - 1} + TSPI \times ( T {V}_{{N}_{min}} + K ) )}^{{K}_{4}}} ) π ) ) ) \qquad ( 26 )$$

With the given approximations and assumptions, the interpolated approximation of the buyer's transaction total may be expressed by Equation 27, as follows.

$$T {T}_{N} \approx T {V}_{{N}_{int}} ( 1 + M \times \frac{1}{2} ( 1 - cos ( ( {K}_{2} - \frac{{K}_{1}}{{K}_{3} + {( T {S}_{N - 1} + TSPI \times ( T {V}_{{N}_{Int}} + K ) )}^{{K}_{4}}} ) π ) ) ) \qquad ( 27 )$$

Equation 27 will always be true within an undetermined precision level. The precision level needed for the described securities exchange may be approximately $0.01 for all transactions. Implementation may indicate a higher level of precision is necessary, and similar equations as the provided examples may be utilized to achieve varying degrees of precision. Furthermore, one may interpolate the buyer's transaction total, TV_{N}_{_{Int}}, given any two trade values that are sufficiently or relatively close to each other. This interpolation is described by Equation 28, as follows.

$$T {T}_{{N}_{Int}} \approx T {V}_{{N}_{1}} + \frac{T {V}_{{N}_{2}} - {TV}_{{N}_{1}}}{{TT}_{T {V}_{{N}_{2}}} - {TT}_{T {V}_{{N}_{1}}}} \times \frac{T {T}_{{N}_{D e s i r e d}} - T {T}_{T {V}_{{N}_{1}}}}{{TT}_{T {V}_{{N}_{2}}} - {TT}_{T {V}_{{N}_{1}}}} \qquad ( 28 )$$

wherein:

$${TT}_{{TV}_{{N}_{2}}} = {TV}_{{N}_{2}} ( 1 + M \times \frac{1}{2} ( 1 - cos ( ( {K}_{2} - \frac{{K}_{1}}{{K}_{3} + {( {TS}_{N - 1} + TSPI \times ( {TV}_{{N}_{2}} + K ) )}^{{K}_{4}}} ) π ) ) ) \qquad ( 29 )$$

$${TT}_{{TV}_{{N}_{1}}} = {TV}_{{N}_{1}} ( 1 + M \times \frac{1}{2} ( 1 - cos ( ( {K}_{2} - \frac{{K}_{1}}{{K}_{3} + {( {TS}_{N - 1} + TSPI \times ( {TV}_{{N}_{1}} + K ) )}^{{K}_{4}}} ) π ) ) ) \qquad ( 30 )$$

Whether two trade values are sufficiently close to each other may be determined, for example, by evaluating whether TV_{N2} minus TV_{N1} are less than a given or calibrated tolerance value.

The above exemplary determinations provide alternative ways of arriving at the buying power of the buyer's offer. A computerized method may include a plurality of algorithms for brokering trades and may follow a procedure that maximizes efficiency by selecting particular algorithms for a particular candidate transaction when it makes the most sense to do so.

### Brokering

Brokering is described as the act or method step of creating a trade deal between at least one buyer and at least one seller. Buyers and sellers create trade offers with specific terms for what kind of deal they are willing to accept. In one exemplary method to operate a computerized securities exchange, the system may periodically process a list of new trade offers and may sort or match them on a first-come-first-serve basis.

### Matchmaking

A securities exchange may serve as a direct registry for all securities traded on the exchange. This registry or record is updated in regular intervals to reflect new trade offers and subsequently new trades. When pending trade offers are added to the exchange, they are put through a matchmaking process.

The matchmaking process may start by assessing each new trade offer one by one on a first-come-first-serve basis. For each new purchase offer, the list of active counteroffers or active sale offers is referenced to determine if any matches can be made. Compatibility or a purchase offer to a sale offer may be determined by valuation. A pairing of a purchase offer and sale offer for a particular security or quantity of securities wherein the purchaser offers a higher or equal valuation than that of the sale offer. For each match found, the system determines a quantity of shares or a quantity of security instruments to be transferred from the seller to the buyer based on the conditions of their respective offers. Once an agreeable trade has been brokered, it is executed automatically. Such a trade execution may or may not exhaust the total offer of the purchaser or the seller. In the case of an incomplete or partially fulfilled offer, this process is repeated until each trade offer is exhausted (escrow completely depleted from trades) or added to the appropriate list of active sale or purchase trade offers.

### Trade Confirmation and Execution

Once the trading fees are set and the total value of the securities being traded are finalized, the trade is ready to be executed. The buyer receives ownership rights to the securities being traded and the total transaction cost charged to the buyer equals the total value of the securities plus the determined trading fee for the buyer. The seller receives as proceeds to the transaction the total value of the securities being traded minus the determined trading fee for the seller.

According to one exemplary embodiment, the disclosed system includes at least one computerized processor executing programmed code or instructions configured to operate a securities exchange. The one or more computerized processors are configured to execute the following steps: the processor(s) acquire trading history: the system acquires a comprehensive trading history for the party involved in the sale and purchase transaction. This trading history includes data on a plurality of historical sale and purchase transactions in which the party has participated. The processor(s) further identify time and valuation variables within the acquired trading history: for each historical transaction, the system identifies a valuation variable, which may include the transaction amount, stock price, or other relevant financial metrics. The system also identifies a time variable for each transaction, which may include the time elapsed since the transaction or the duration of the transaction. The processor(s) further determine a stock trading fee: the system calculates the stock trading fee for the current transaction based on the identified valuation and time variables. The fee determination process involves: charging increasing fees for transactions with relatively smaller time variables, incentivizing longer holding periods, and/or with relatively larger valuation variables, reflecting the higher value of the transactions. The processor(s) further generate an output based on the determined stock trading fee. This output can be used to request or confirm authorization of the transaction, for billing, for reporting, or other analysis.

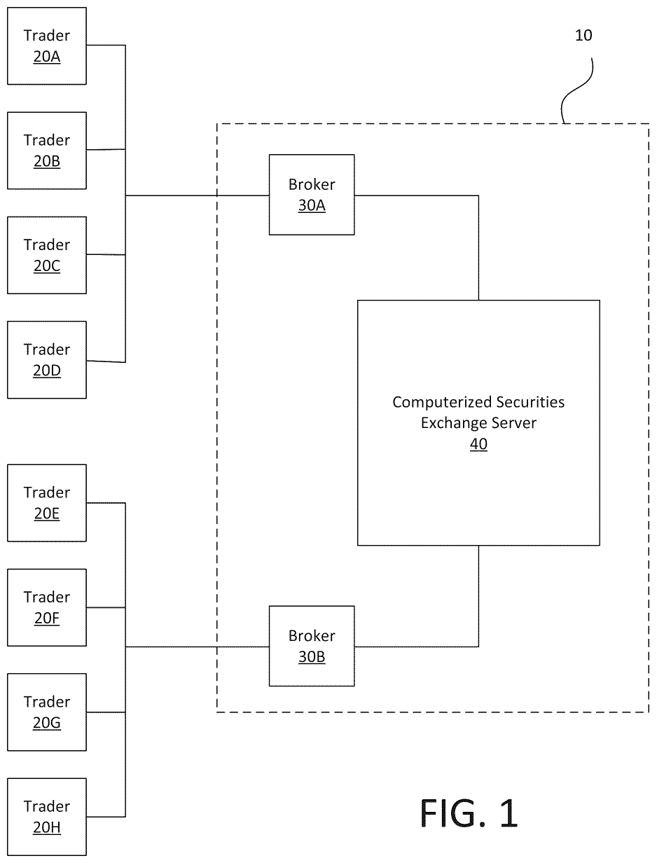

With reference to FIG. 1, a system 10 for determining a securities trading fee for a sale and purchase transaction is presented. The system 10 is illustrated including a computerized securities exchange server 40. The securities exchange server 40 includes a computerized processor configured to operate programmed code useful to operate a marketplace upon which a buyer and a seller may conduct a sale and purchase transaction to transfer ownership of a security. A security may include a stock denoting an ownership interest in a company, a bond or other debt instrument, a commodity or a futures contract for a commodity, or other tradable investment instrument. The system 10 may include one or more brokers 30A, 30B, or one or more brokers may exist outside of and in communication with the system 10. A plurality of traders 20A, 20B, 20C, 20D, 20E, 20F, 20G, 20H are illustrated in communication with one of the brokers 30A, 30B. Any one of the traders 20A, 20B, 20C, 20D, 20E, 20F, 20G, 20H may be a party to a transaction to be executed upon or by the system 10. Traders 20A, 20B, 20C, 20D, 20E, 20F, 20G, 20H are exemplary, brokers 30A, 30B are exemplary, and any number of traders and brokers may simultaneously access and utilize the securities exchange server 40.

The securities exchange server 40 is, in some embodiments, an industrial server configured to communicate and handle thousands or millions of transactions in a very short time. Such a server may be described as a high-frequency, low-latency server. Such a server may be described as a high-frequency trading infrastructure device which may include the following exemplary configuration: processors: high-speed central processing units (CPUs) (e.g., AMD® Ryzen® 7950X, Intel® Xeon® w9 series); memory: 64-1024 GB RAM configured for handling large datasets; storage: non-volatile memory (NVMe) solid state drives (SSDs) for ultra-fast data access; networking: low-latency switches and routers, 10 Gigabits per second+network interfaces, configurations and communications hardware configured for sub-millisecond latency; cooling: liquid cooling systems to maintain performance under load; accelerators: field-programmable gate arrays (FPGAs) for parallel processing and ultra-low latency and application specific integrated circuits (ASICs) for specialized algorithm execution. Examples of such high-frequency, low-latency server devices may be purchased through companies such as ChartVPS™ which is offered by Nitrode Corporation of San Francisco, California, U.S. and Ciara Orion which is offered by Hypertec of Saint Laurent, Quebec, Canada.

Brokers 30A, 30B may use a wide variety of devices to facilitate and order trades for traders. Large-scale brokers may use similar high-frequency, low-latency server devices as described for use in the securities exchange server 40. Smaller-scale brokers or brokers that batch trade orders, for example, making once a day orders, may use lower capacity or less expensive server devices or computerized systems. Traders 20A, 20B, 20C, 20D, 20E, 20F, 20G, 20H may use a wide variety of devices to communicate with the brokers 30A, 30B or the securities exchange server 40. Large traders 20A, 20B, 20C, 20D, 20E, 20F, 20G, 20H, such as multi-billion-dollar hedge funds, may use similar high-frequency, low-latency server devices as described for use in the securities exchange server 40. Day traders may utilize more conventional computer devices, for example, in combination with communications devices that are inherently fast and reliable, such as Internet access provided by fiber-optics networks. Average or single person traders investing retirement resources may utilize consumer electronics, such as a smartphone operating an iOS® or Android® operating system.

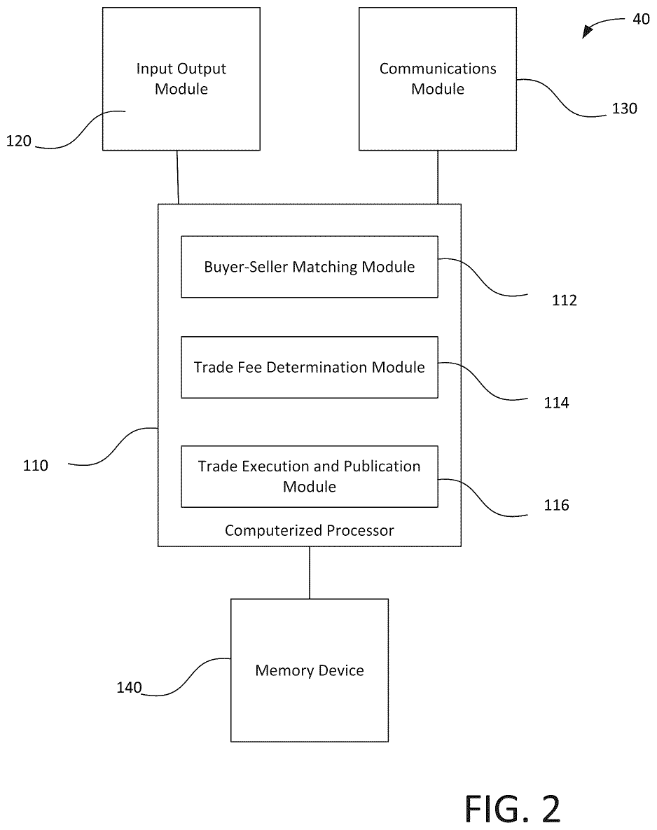

FIG. 2 schematically illustrates the securities exchange server 40 of FIG. 1. The securities exchange server 40 includes a computerized processor 110, an input output module 120, a communications module 130, and a memory device 140. The computerized processor 110 is configured to execute programmed code, includes access to random-access memory (RAM), and may operate an operating system configured to facilitate the execution of code within the processor 110. The input output module 120 may include human input devices such as a mouse or keyboard, may include visual displays such as a touchscreen device, and may include other similar input and output devices such as an interface with a smartphone device. Communications module 130 enables communication of the securities exchange server 40 with external computers, devices, servers, the brokers 30A, 30B of FIG. 1, and other parties or reference sources as required to operate the securities exchange server 40. The communications module 130 may be connected to the Internet or other similar communications network, may include encrypted communications and/or other security protocols, and enables an exchange of data useful to securities trading and execution of trades. The memory device 140 may include a hard drive, a flash drive, or other similar durable memory storage devices and may store programming which may be operable upon the processor 110, details regarding securities traded upon the securities exchange server 40, historical data including details of parties that utilized the securities exchange server 40 such as a trading history for each of the parties, and other similar information. Information created and accessed by the securities exchange server 40 may alternatively and/or additionally utilize Blockchain technology to securely record and maintain records of securities ownership and records of executed transactions.

The processor 110 is configured to operate software or discrete programming packages configured to achieve certain results in the processor 110. In one example of how the processor 110 may operate, the processor 110 is illustrated including a buyer-seller matching module 112 including programming configured to monitor incoming orders from the traders 20A, 20B, 20C, 20D, 20E, 20F, 20G, 20H of FIG. 1 and utilize valuation of the security to be traded to match a specific buyer with a specific seller. The trade fee determination module 114 may utilize methods disclosed herein to determine a trading fee to charge each of the buyer and the seller for the transaction to be executed. The trade execution and publication module 116 may perform tasks necessary to record and duly register changed ownership of the security being transferred and may order the transfer of funds in accordance with the terms of the executed transfer. A number of programming modules may additionally or alternatively be utilized within the processor 110, a number of example programming modules are envisioned, and the disclosure is not intended to be limited to the examples provided herein.

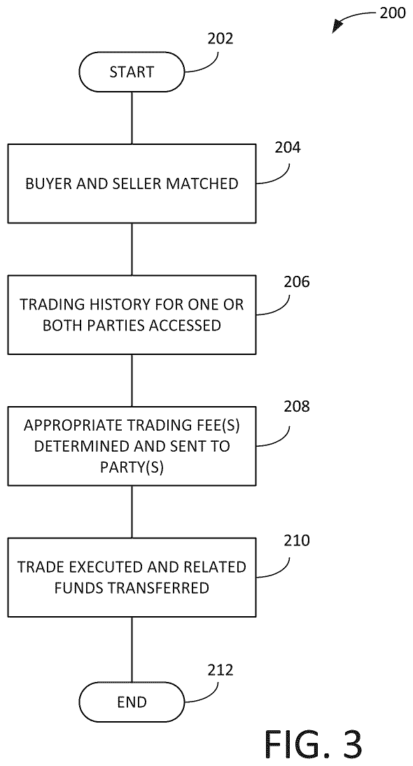

FIG. 3 is a flowchart illustrating a exemplary method 200 to determine trading fees for a pending transaction and subsequently execute the transaction. The method 200 is envisioned for use with the system 10 of FIG. 1, although the method 200 may be utilized with a variety of physical computerized systems, and the disclosure is not intended to be limited to the examples provided herein. At step 202, the method 200 starts. At step 204, a buyer and a seller for the pending transaction are matched, with a particular security or group of securities to be traded for an agreed upon price. At step 206, a trading history for one of the parties to the transaction or trading histories for both the buyer and the seller are accessed. At step 208, an appropriate trading fee or trading fees are determined based upon determinations disclosed herein, taking into account the trading history or histories, and the fee or fees are sent to the party or parties for approval or confirmation. At step 210, the trade is executed, and the related funds are transferred. At step 212, the method 200 ends. The method 200 is provided as an exemplary method for determining a trading for a sale and purchase transaction. A number of additional and/or alternative steps are envisioned, and the disclosure is not intended to be limited to the examples provided herein.

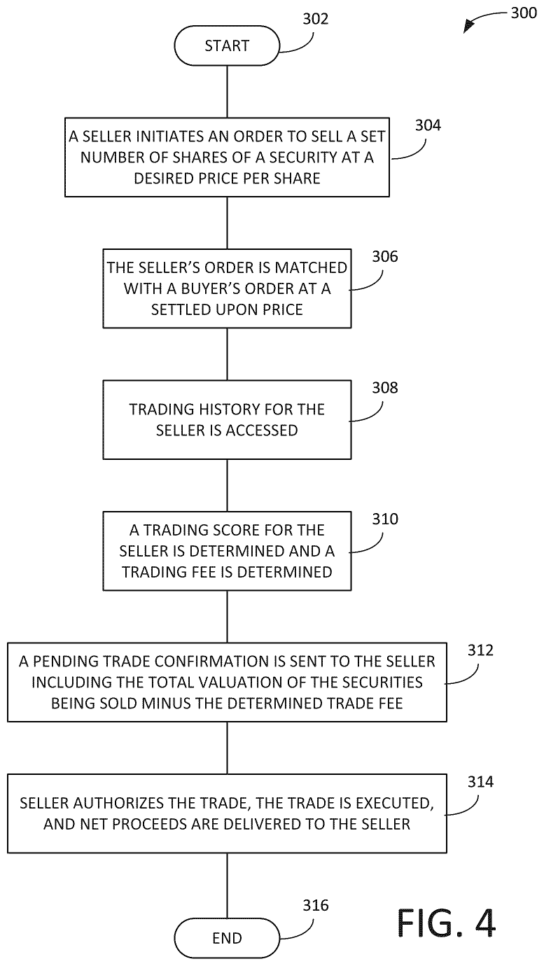

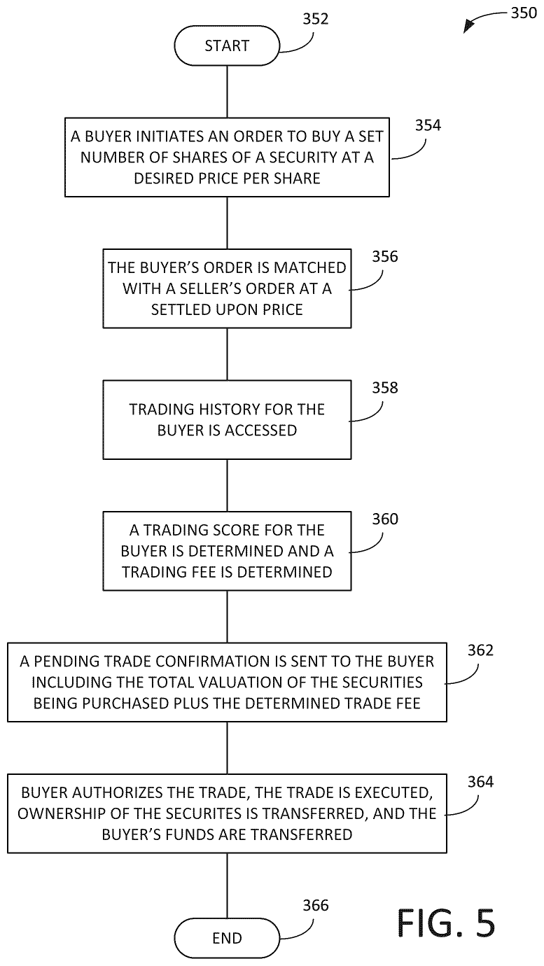

FIG. 4 is a flowchart illustrating an exemplary method 300 to execute a trade for a seller in a sale and purchase transaction. The method 300 is envisioned for use with the system 10 of FIG. 1, although the method 300 may be utilized with a wide variety of physical computerized systems, and the disclosure is not intended to be limited to the examples provided herein. At step 302, the method 300 starts. At step 304, a seller initiates an order to sell a set number of shares of a security at a desired price per share. At step 306, the seller's order is matched with a buyer's order at a settled upon price. For either the buyer or the seller, the transaction being described may be a portion of an overall order involving more shares and other trading partners, i.e., a single seller may need to be matched with a plurality of buyers to fulfill the entire order. At step 308, a trading history for the seller is accessed. At step 310, a trading score for the seller is determined based upon the trading history, and a trading fee is determined for the seller based upon the trading score. At step 312, a pending trade confirmation is sent to the seller including total valuation of the securities being sold minus the determined trading fee. At step 314, the seller authorizes the trade, the trade is executed, and net proceeds from the sale are delivered to the seller. At step 316, the method 300 ends. The method 300 is provided as an exemplary method for executing a trade for a seller in a sale and purchase transaction. A number of additional and/or alternative steps are envisioned, and the disclosure is not intended to be limited to the examples provided herein.

FIG. 4 is a flowchart illustrating an exemplary method 350 to execute a trade for a buyer in a sale and purchase transaction. The method 350 is envisioned for use with the system 10 of FIG. 1, although the method 350 may be utilized with a wide variety of physical computerized systems, and the disclosure is not intended to be limited to the examples provided herein. At step 352, the method 350 starts. At step 354, a buyer initiates an order to purchase a set number of shares of a security at a desired price per share. At step 356, the buyer's order is matched with a seller's order at a settled upon price. For either the buyer or the seller, the transaction being described may be a portion of an overall order involving more shares and other trading partners, i.e., a single buyer may need to be matched with a plurality of sellers to fulfill the entire order. At step 358, a trading history for the buyer is accessed. At step 360, a trading score for the buyer is determined based upon the trading history, and a trading fee is determined for the buyer based upon the trading score. At step 362, a pending trade confirmation is sent to the buyer including total valuation of the securities being sold plus the determined trading fee. At step 364, the buyer authorizes the trade, the trade is executed, the ownership of the shares being purchased are transferred to the buyer, and the buyer's funds totaling the agreed upon sale price of the securities plus the trading fee are transferred from the buyer's account or an established escrow account. At step 366, the method 350 ends. The method 350 is provided as an exemplary method for executing a trade for a buyer in a sale and purchase transaction. A number of additional and/or alternative steps are envisioned, and the disclosure is not intended to be limited to the examples provided herein.

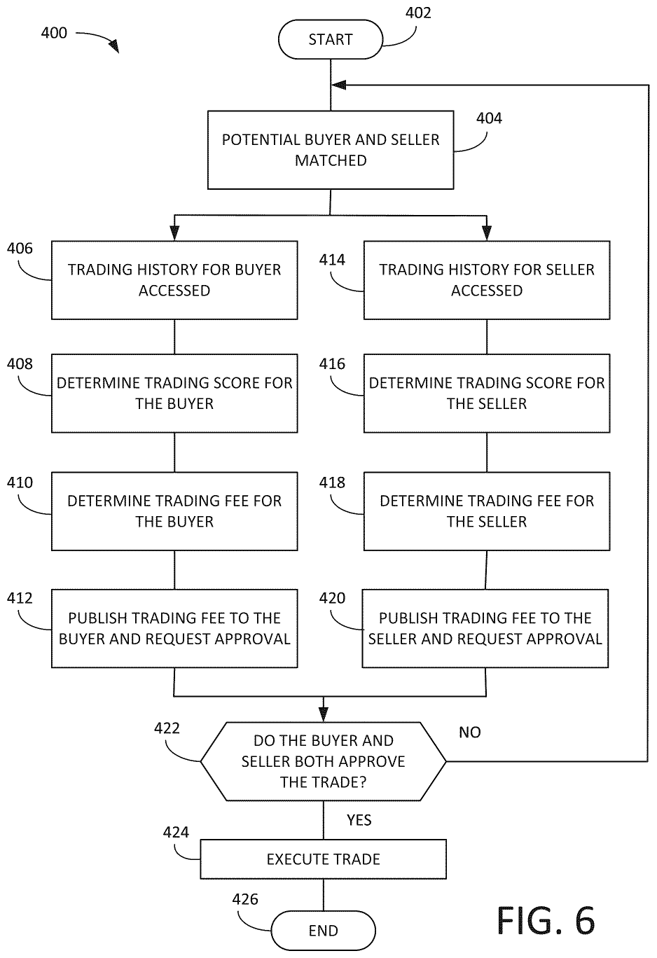

FIG. 6 is a flowchart illustrating a method 400 for determining trade details including trade fees for both a buyer and a seller to a transaction, confirming approval of both the buyer and the seller, and executing the pending transaction. The method 400 is envisioned for use with the system 10 of FIG. 1, although the method 400 may be utilized with a wide variety of physical computerized systems, and the disclosure is not intended to be limited to the examples provided herein. At step 402, the method 400 starts. At step 404, a potential buyer and seller are matched. Matching is based upon the valuation of the securities in the orders of each party. In one embodiment, two orders are matches by having desire valuations within a certain range of each other. An agreed upon valuation may be an average of the seller's valuation and the buyer's valuation. In another embodiment, the valuation may be set to the seller's valuation, and the seller may be matched with a buyer and a pending transaction defined when a buyer willing to pay the seller's valuation is identified. Pairing may be performed on a first-come-first-served basis, with older orders taking priority over newer orders. Unmatched orders, for example, including a buyer's order that is too low to presently be matched with a seller's order, may remain an open order for some defined time period.

Steps 406 through 412 describe preparing the buyer's portion of the transaction for approval. At the step 406, a trading history for the buyer is accessed. At step 408, a trading score for the buyer is determined based upon the buyer's trading history. At step 410, a trading fee for the buyer is determined based upon the buyer's trading score. At the step 412, the determined trading fee is published to the buyer, and approval is requested from the buyer.

Steps 414 through 420 describe preparing the seller's portion of the transaction for approval. At the step 414, a trading history for the seller is accessed. At step 416, a trading score for the seller is determined based upon the seller's trading history. At step 418, a trading fee for the seller is determined based upon the seller's trading score. At the step 420, the determined trading fee is published to the seller, and approval is requested from the seller.

At step 422, a determination is made whether both the buyer and the seller approved the transaction. If either the buyer at the step 412 or the seller at the step 420 did not approve the transaction, the transaction is cancelled and the method 400 returns to the step 404, wherein each of the buyer and the seller may be matched with a new trade partner. An optional step may occur wherein the party that did not approve the transaction may cancel or amend their order. If both the buyer and seller approved the transaction, the method 400 advances to step 424 wherein the trade is executed. At step 426, the method 400 ends. The method 400 is provided as an exemplary method for determining trade details including trade fees for both a buyer and a seller to a transaction, confirming approval of both the buyer and the seller, and executing the pending transaction. A number of additional and/or alternative steps are envisioned, and the disclosure is not intended to be limited to the examples provided herein.

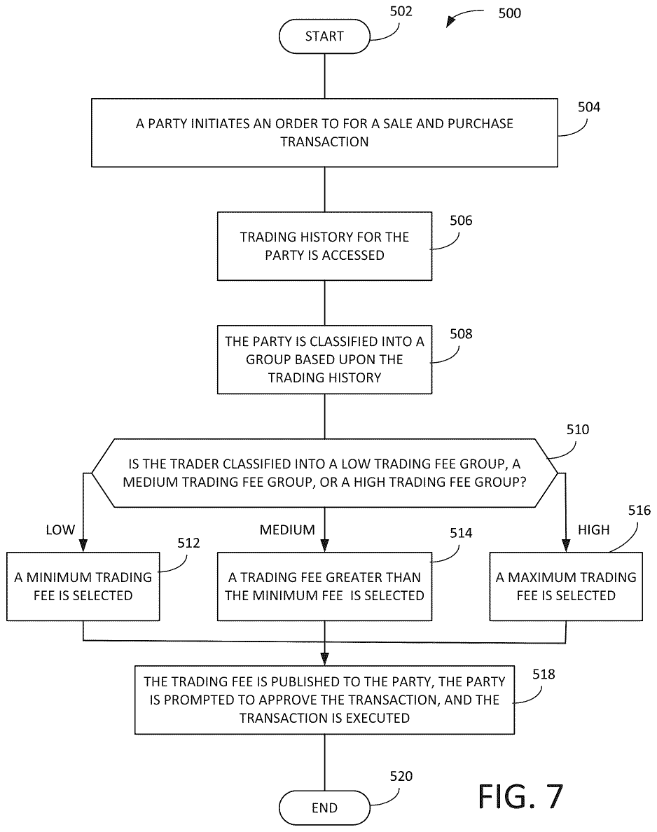

FIG. 7 is a flowchart illustrating an exemplary method 500 to classify a party to a transaction into a defined fee group based upon a trading history of the party. The method 500 is envisioned for use with the system 10 of FIG. 1, although the method 500 may be utilized with a wide variety of physical computerized systems, and the disclosure is not intended to be limited to the examples provided herein. At step 502, the method 500 starts. At step 504, a party initiates an order, either a sale order or a purchase order, for a sale and purchase agreement. The order may include a desired valuation of the security. The valuation may be on a per share basis (e.g., I want to sell shares of Company X at $20 per share) or may include a total valuation of the transaction desired (e.g., I want to buy $20,000 of Company X's shares at a current market price.) The order may include a total quantity or number of shares or quantity of the security. The order may include a time limit for the order to be fulfilled. The order may include a price range away from the desired valuation that the party is willing to compromise. At step 506, a trading history for the party is accessed. At step 508, the party is classified into a defined fee group based upon the trading history of the party. At step 510, the party is sorted based upon the defined fee group into which the party was classified. In the example of FIG. 7, three defined fee groups are illustrated. Any number of defined fee groups may be utilized.

In the example of FIG. 7, the party is sorted into one of a low trading fee group, a medium trading fee group, and a high trading fee group. If the party is classified into the low fee group, the method 500 advances to step 512, wherein an exemplary minimum trading fee is selected. If the party is classified into the medium trading fee group, the method 500 advances to step 514, wherein a trading fee greater than the minimum trading fee is selected. If the party is classified into the high trading fee group, the method 500 advances to step 516, wherein a maximum trading fee is selected. The trading fees of the groups illustrated in FIG. 7 are examples. In one embodiment, one or more the groups may have a fixed fee, e.g., $50, charged for a transaction. In another embodiment, one or more groups may have a fixed fee per share (e.g., $2 per share), a percentage of valuation if the transaction or a fixed fee per incremental valuation of the transaction (e.g., 2% of the transaction value or $10 per charged $500 of the valuation of the transaction). In another embodiment, one or more groups may have a scalar determination applied to the fee, for example, with the middle group being charged based upon whether they are closer to being in the low fee group or closer to being in the high fee group. A number of methods to set the trading fees are envisioned, and the disclosure is not intended to be limited to the examples provided herein.

At step 518, the trading fee is published to the party, the party is prompted to approve the transaction, and the transaction is executed. The method 500 ends at step 520. The method 500 is provided as an example for a method to classify a party to a transaction into a defined fee group based upon a trading history of the party. A number of additional and/or alternative method steps are envisioned, and the disclosure is not intended to be limited to the examples provided herein.

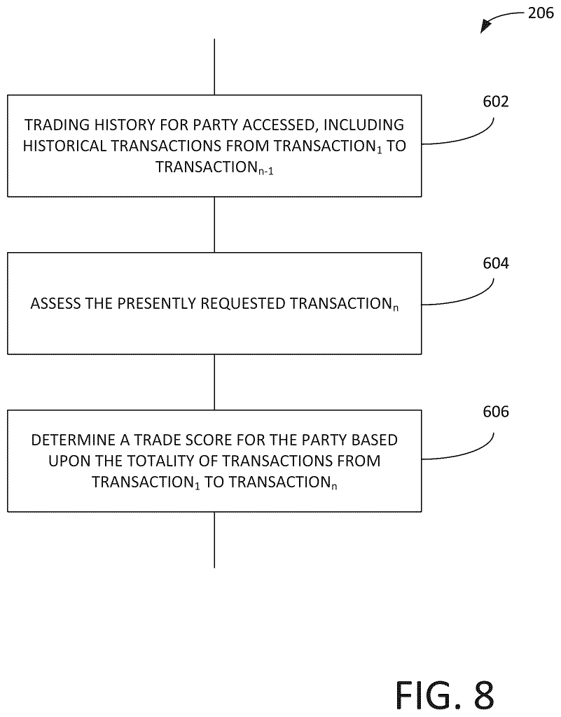

FIG. 8 is a flowchart illustrating an exemplary method to access a trading history for one of the parties to a transaction including assessment of an effect of a presently requested transaction. In one embodiment, FIG. 8 may be described as further explanation of what operations may occur during step 206 of the method 200 of FIG. 3, wherein a trading history for one or both parties to the transaction is accessed. Sub-steps 602, 604, and 606 are defined. In the sub-step 602, a trading history for a party to the present transaction is accessed, including time and valuation factors for each of a plurality of historical transactions from a first transaction, TRANSACTION₁, to a most recent historical transaction, TRANSACTIONₙ₋₁. At the sub-step 604, terms of a presently requested transaction, TRANSACTIONₙ, are assessed. At the sub-step 606, a trade score for the party is determined based upon the totality of the transactions from TRANSACTION₁, to a most recent historical transaction, TRANSACTIONₙ. A number of alternative processes for accessing a trading history of a party to a transaction are envisioned, and the disclosure is not intended to be limited to the examples provided herein.

The disclosed system and method may include additional processes. For example, the securities exchange or brokerage programming useful to interact with the securities exchange may be configured to aid a user in optimizing fees or taxes. Trading fee variables and trading score factors may be published, such that it may be knowable or determinable what trading behaviors will increase fees. For example, a user may indicate a desire to buy or sell a block of securities, for example, including a current valuation of one million dollars. A process may be employed to enable the user to trade securities over time, for example, over a two-month period, wherein increased fees are avoided by avoiding trading over a threshold frequency and over a threshold valuation. The process may enable an exemplary user to initiate an order, “Over the next two months, buy shares of company X at a maximum price of $50 per share, up to a maximum purchase amount of one million dollars, and only execute trades that keep my trading score below 200.”

Central to the functioning of the PIES Economy™ is a novel pricing model. This pricing is calculated via an equal process for every participant with equitable, but not equal, results. These results encourage good investing strategy, limit market manipulation and volatility, protect small investors, mitigate wealth inequality, and more. An exemplary description of fees and method parameters that may be implemented in the disclosed methods in response to particular trading behaviors is provided.

The following is exemplary. The exact fees that will be implemented in the PIES Exchange may vary depending upon a number of factors and policy decisions. The fees herein demonstrate the relationships between different trading scenarios for one consistent but hypothetical calibration set. The exemplary values are provided to demonstrate the relationships which may be created and reinforced by the disclosed methods. Working-class persons frequently value both financial success and the broader impact their investments can create on society. Such exemplary persons may save on average about $50 per month, but this is a wide-ranging demographic with wide-ranging abilities to save from between $10 and $10,000 per month. They occasionally need to cash in on their investments to pay for life events, like buying a house or having a baby.

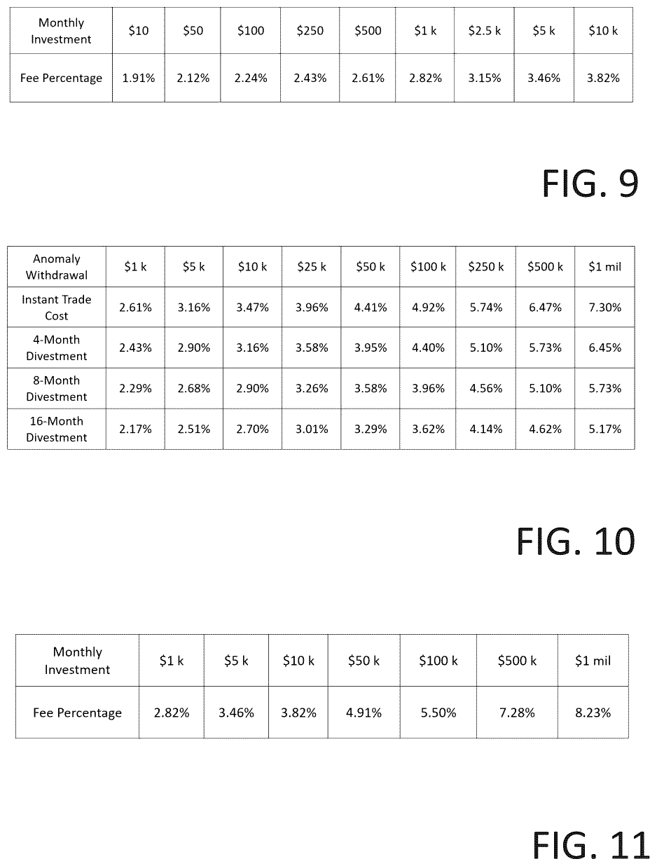

FIG. 9 is a table illustrating exemplary results of slow and steady saving scenarios in relation to the disclosed methods. A first row of the table illustrates a monthly investment that an individual makes. A second row of the table illustrates a fee percentage that the individual may pay. Such individuals may mostly put money into their account and rarely take it out. These fee scenarios represent the steady-state pricing for the exemplary investors. According to the disclosed methods, this is an advantageous investing strategy. The table of FIG. 9 shows the steady-state fee percentage for someone who is consistently investing the amount listed per month. One may see that small investors pay a nominal fee, while larger investors with more purchasing power pay a modestly higher fee. One may see that the disclosed methods provide for equity among different wealth levels of investors, providing enhanced incentives for those with modest incomes to invest.

Slow and steady savers save for milestone life events like having a baby or buying a house. In an ideal scenario, the investor knows how much they will need and they plan in advance to acquire it. The more slowly their portfolio is divested, the less they will pay in fees. FIG. 10 is a table illustrating exemplary milestone withdrawal scenarios in relation to the disclosed methods. The table of FIG. 10 shows withdrawals and the associated approximate fee percentages for different divestment speeds. A first row of the table illustrates an anomalous withdrawal amount. The second through fifth rows illustrate fee impacts of taking the withdrawal amount out in an instant one-time trade or in spreading the withdrawal out over a several month divestment period. A second row of the table illustrates fee results for an instant divestment trade cost. A third row of the table illustrates fee results for a four-month divestment scheme. A fourth row of the table illustrates fee results for a eight-month divestment scheme. A fifth row of the table illustrates fee results for a sixteen-month divestment scheme. One may see that the disclosed methods provide for equity among investors, benefitting those that opt for structured, over-time divestment schemes as opposed to those that want their money immediately despite any externalities that such immediate divestment may create.

Capitalism has strengths. Large amounts of money may be quickly raised to back profitable ventures. The benefits of successful investing may spread the profits for such successful ventures over large parts of the population. Un-tempered capitalism may lead to externalities or unfair distribution of the benefits of the system. Larger, more powerful entities may use their influence to corner the market or reap the primary benefits of the market, leaving smaller, weaker parties to receive little or no benefit from the overall advancement of the system. Large investment firms practice methods that are problematic, for example, jumping into and out of investment positions at optimal times to reap the most profit out of the positions as possible. Such large firms may be positioned to receive and act upon news and newly published reports that members of the public may not be able to act upon in a timely manner. The methods disclosed herein are provided as a way to compensate for this behavior as a solution to this problem. All may act upon and benefit from investment opportunities, but larger, more powerful entities are prevented by progressive fee schedules from predatorily taking all of the profits before the wider investment has an opportunity to partake in the action.

The disclosed methods may treat institutional investors differently from individual investors. An institutional investor may frequently have some other core purpose and may utilize investments as a savings or accounting tool. Such institutional investors may include anything from home-owners associations (HOAs), to municipalities, to universities, to small and large businesses. Many organizations, public, private or hybrid, will want to invest in a system that prioritizes longevity and stability. These investors may invest anything from $1000 to $10,000,000 per month. Their investing behavior is predictable and steady. They like low risk. They rarely make larger withdrawals or investments. The bigger they are, the more they pay towards the common good of the participants of the PIES Economy™.

FIG. 11 is a table illustrating exemplary results of long-term investing scenarios in relation to the disclosed methods. Institutions will pay more than most individuals due to their size, but adhering to long-term investing strategies will still minimize their fees. A first row of the table illustrates a monthly investment amount that the institution may make. A second row of the table illustrates a fee percentage that the institution may pay. One may see that the disclosed methods provide for equity among different wealth levels of institutional investors, providing enhanced incentives for those with modest incomes to invest. In comparison with FIG. 9, one may see that the disclosed methods favor individuals over institutional investors, attempting to equalize factors of power, wealth accumulation, and influence that may tend to accrue in institutions and, in particular, larger institutions as compared to small investors.

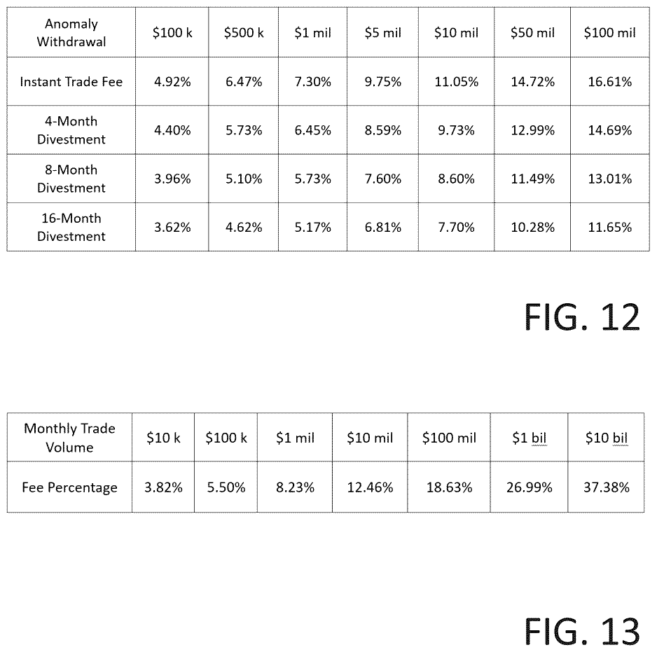

Rarely, institutional investors may find themselves with a large influx of cash from a donation or other fortunate scenario. Unfortunate scenarios also happen rarely but may require equally large trades. These scenarios result in higher fees, which can be mitigated by more slowly adding to or subtracting from their portfolio. FIG. 12 is a table illustrating exemplary anomalous scenarios in relation to the disclosed methods. A first row of the table illustrates an anomalous withdrawal amount. The second through fifth rows illustrate fee impacts of taking the withdrawal amount out in an instant one-time trade or in spreading the withdrawal out over a several month divestment period. A second row of the table illustrates fee results for an instant divestment trade cost. A third row of the table illustrates fee results for a four-month divestment scheme. A fourth row of the table illustrates fee results for a eight-month divestment scheme. A fifth row of the table illustrates fee results for a sixteen-month divestment scheme. One may see that the disclosed methods provide for equity among institutional investors, benefitting those that opt for structured, over-time divestment schemes as opposed to those that want their money immediately despite an externalities that such immediate divestment may create.

The disclosed methods may treat specialize or dedicated investment firms differently from individual investors or institutional investors. Such investment firms dedicate core resources to analyzing and predicting investment market behaviors. Such investment firms frequently have insight or processes for maximizing profits based upon market and securities fluctuations. Without any check or counteraction of these insights and processes, investment firms may take a lion's share of value from a market. Externalities caused by investment firms may have substantial impacts upon other members of the investment community. FIG. 13 is a table illustrating exemplary results of institutional long-term investing scenarios in relation to the disclosed methods. Behaviors encouraged by the disclosed methods are substantially more affordable than the discouraged behaviors at this scale and size. Investment firms may make fairly consistent trades throughout the month with total monthly volumes ranging from small to very large. A first row of the table illustrates a monthly investment amount that the investment firm may make. A second row of the table illustrates a fee percentage that the investment firm may pay. One may see that the disclosed methods provide for equity among different wealth levels of investment firms, providing special incentive for firms to invest regularly and stay in regular trading patterns that minimize total fees paid. A firm investing $10 million per month for ten months is going to pay far less fees than a similar firm investing $100 million once. In comparison with FIG. 9, one may see that the disclosed methods favor individuals and institutional investors over investment firms, attempting to equalize factors of power, wealth accumulation, and influence that may tend to accrue in investment firms and, in particular, larger investment firms as compared to other persons or entities.

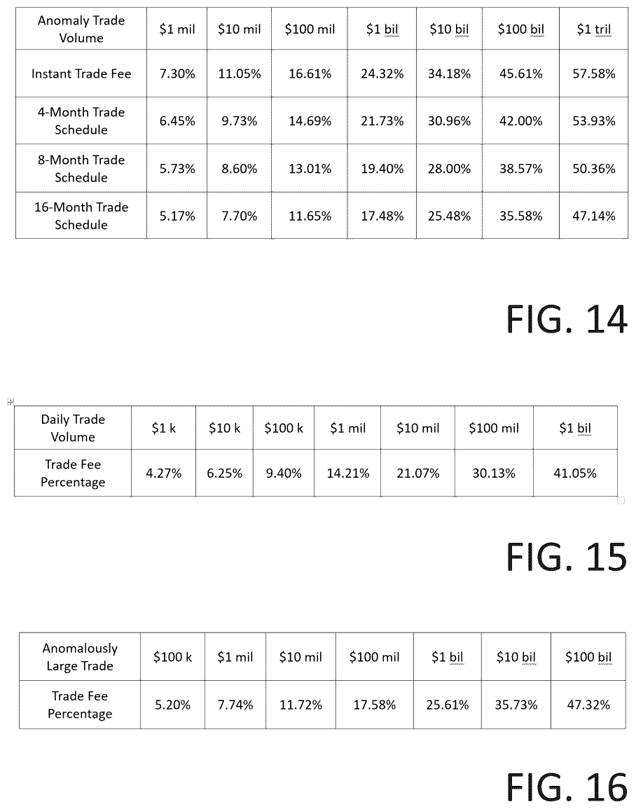

Investment firms do bear the responsibility of exercising good judgment about the value of investments. If they determine that stock is significantly under or overvalued, they may decide to make a correspondingly significant trade. These trades may not significantly alter their incurred fees unless it shifts the overall total monthly volume in a significant way. FIG. 14 is a table illustrating exemplary market correction scenarios in relation to the disclosed methods. A first row of the table illustrates an anomalous withdrawal amount. The second through fifth rows illustrate fee impacts of taking the withdrawal amount out in an instant one-time trade or in spreading the withdrawal out over a several month divestment period. A second row of the table illustrates fee results for an instant divestment trade cost. A third row of the table illustrates fee results for a four-month divestment scheme. A fourth row of the table illustrates fee results for a eight-month divestment scheme. A fifth row of the table illustrates fee results for a sixteen-month divestment scheme. One may see that the disclosed methods provide disincentives for investment firms to make sudden, high value changes in their investments but instead provide encouragement for investment firms to make changes in investment positions over longer periods of time.

The disclosed methods seek to discourage wasteful behavior and, in particular, wasteful behavior that has wide impacts upon the investment community. For example, those that gamble on short-term trends in the market have large, unfair impacts on market behavior and the wellbeing of the investment community. Such entities may include day-traders as individuals and quantitative analysis firms as large investment firms.

FIG. 15 is a table illustrating exemplary results of day-trading scenarios in relation to the disclosed methods. A first row of the table illustrates exemplary daily trade volumes as a total daily value. A second row of the table illustrates a fee percentage that the entity may pay. One may see that large fees may be utilized to discourage wasteful trading practices.

FIG. 16 is a table illustrating exemplary results of jackpot scenarios in relation to the disclosed methods. This table illustrates scenarios for fees charged when an entity cashes-out on a large windfall. A first row of the table illustrates an anomalous trade amount. A second row of the table illustrates a fee percentage that the entity may pay. One may see that large instant withdrawals of windfall profits may result in large or prohibitive fees as a way to discourage such behavior.

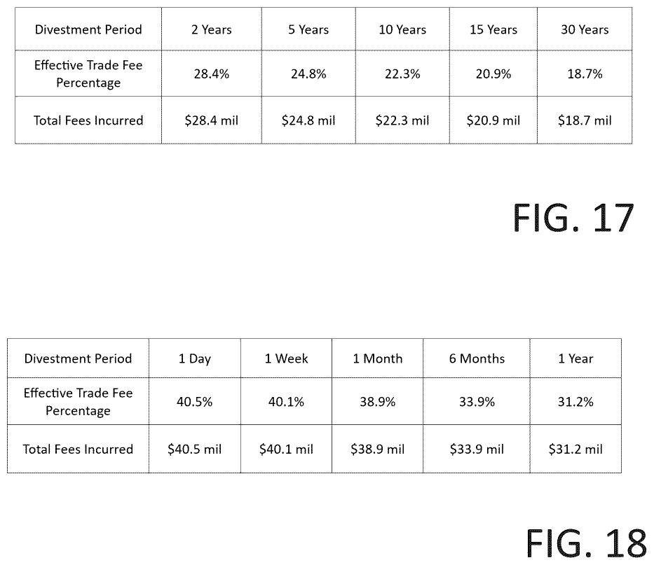

FIG. 17 is a table illustrating exemplary results of scheduled divestment scenarios in relation to the disclosed methods. An exemplary entity wishing to divest of $100 billion is provided, with illustrated fee percentages and total fees incurred over a variety of longer-term divestment windows. A first row of the table illustrates a divestment period or the length of time over which the exemplary $100 billion is removed from the market. A second row of the table illustrates a fee percentage that the entity may pay. A third row of the table illustrates how much money in fees the individual will pay, corresponding to the different divestment periods. One may see that wealthy individuals and entities may be encouraged to make considered plans that do not quickly change investment positions.

FIG. 18 is a table illustrating exemplary results of rapid divestment scenarios in relation to the disclosed methods. An exemplary entity wishing to divest of $100 billion is provided, with illustrated fee percentages and total fees incurred over a variety of short-term or same day divestment windows. A first row of the table illustrates a divestment period or the length of time over which the exemplary $100 billion is removed from the market. A second row of the table illustrates a fee percentage that the entity may pay. A third row of the table illustrates how much money in fees the individual will pay, corresponding to the different divestment periods. One may see that entities may be encouraged to make considered plans that do not quickly change investment positions and may be strongly discouraged from panic selling or quickly liquidating positions.

In one alternative, a method or system to improve operation of a very specific type of computerized device: a high-frequency, low-latency trading infrastructure device such as is used to execute/operate a securities exchange is described. Such a specific type of computerized device may be described as a securities exchange server or a server configured for operating a securities exchange. Such a method or system may utilize a progressive fee structure to reduce externalities and unfair influence exerted by high value or investment specialized entities and provide for more equitable results in use of the high-frequency, low-latency trading infrastructure device to the trading public. This trading infrastructure device may be described as executing trades, transferring funds, charging fees from participating traders, executing changes in ownership of the securities involved in the trade, publishing data and statistics, and providing equitable outcomes in market or security ownership.

In another alternative, a method or system executing software code enabling aggregation of influence of a plurality of businesses seeking to provide equitable market access to the investing public is provided. Such businesses may elect to list their securities upon an exchange employing the disclosed high-frequency, low-latency trading infrastructure device, thereby preventing free-access to the shares of the plurality of businesses in the open market. Instead, the plurality of businesses may elect collectively to limit distribution and ownership of the shares to the investment public that chooses to encourage and foster equitable access and fair distribution of profits from the successes of the plurality of businesses by the infrastructure device disclosed herein charging progressive fees to shape and encourage appropriate investing behavior to reduce the occurrence of externalities and unfair trading practices.

In another alternative, a non-transitory computer readable medium storing a computer program comprising instructions which, when executed on at least one processor, cause the at least one processor to execute one or more of the disclosed methods herein is provided.

The disclosed system and method may enable a service to be provided, for example, enabling set investments with protected trading scores. For example, an operator of the exchange could enable individuals to invest up to a set value in a reoccurring, such as monthly, investment service where the investor transfers up to a threshold amount of money to the exchange, the exchange purchases a set or pre-defined mixture of securities for the investor, and the trading score of the investor may be unaffected or protected from increase based upon the protected or exempted reoccurring investment. Similarly, a reoccurring disbursement scheme could be configured by the operator of the exchange to permit a user to take payments from a set of owned securities up to a threshold value per month, and the trading score of the investor may be unaffected or protected from increase based upon the protected or exempted disbursement. In an alternative, a minimum transaction fee or reduced transaction fee could be defined for such conforming activities. Such a process could be described as safe harbor activities within the guidelines of the operated securities exchange.

Outputs generated by the disclosed system and method may take many forms. In some embodiments, generating the output includes charging the securities trading fees to the buyer and to the seller. In some embodiments, generating the output further includes executing the sale and purchase transaction. In some embodiments, generating the output includes discharging funds deposited as execution of the sale and purchase transaction. Public interaction or knowledge of the workings of the disclosed system may be beneficial, for example, to keep the system working towards the stated equitable goals or in fine tuning the aspects of the fees charged. In some embodiments, generating the output includes publishing accumulated statistics for a plurality of sale and purchase transactions to validate equitable purposes of the method. These accumulated statistics may enable public scrutiny and political pressure to facilitate a most equitable outcome possible.

The foregoing disclosure is not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A system for determining a securities trading fee for a sale and purchase transaction, comprising:
one or more computerized processors configured to:
acquire a trading history for a party to the sale and purchase transaction, wherein the trading history describes a plurality of historical sale and purchase transactions in which the party participated;
identify an indicative variable including a valuation variable for each of the plurality of historical sale and purchase transactions or a time variable for each of the plurality of historical sale and purchase transactions;
determine the securities trading fee for the party for the sale and purchase transaction based upon the indicative variable corresponding to each of the plurality of historical sale and purchase transactions, wherein determining the securities trading fee includes charging increasing fees for relatively smaller values of the time variable of the plurality of historical sale and purchase transactions or charging increasing fees when the plurality of historical sale and purchase transactions include relatively larger valuation variable values; and
generate an output based upon the securities trading fee.

2. The system of claim 1, wherein the one or more computerized processors are further configured to:
acquire a trading history for each of a plurality of parties to the sale and purchase transaction;
identify for each of the plurality of parties to the sale and purchase transaction an indicative variable including the valuation variable for each of the plurality of historical sale and purchase transactions or the time variable for each of the plurality of historical sale and purchase transactions;
determine the securities trading fee for each of the plurality of parties to the sale and purchase transaction for the sale and purchase transaction based upon the indicative variable corresponding to each of the plurality of historical sale and purchase transactions; and
generate an output based upon the securities trading fees.

3. The system of claim 1, wherein the one or more computerized processors are further configured to:
identify the valuation variable for each of the plurality of historical sale and purchase transactions;
identify the time variable for each of the plurality of historical sale and purchase transactions; and
determine the securities trading fee for the party for the sale and purchase transaction based upon the valuation variable and the time variable corresponding to each of the plurality of historical sale and purchase transactions.

4. The system of claim 1, wherein the one or more computerized processors are further configured to:
acquire a trading history for each of a plurality of parties to the sale and purchase transaction, wherein the trading history describes a plurality of historical sale and purchase transactions in which the party participated;
identify for each of the plurality of parties to the sale and purchase transaction a valuation variable for each of the plurality of historical sale and purchase transactions;
identify a time variable for each of the plurality of historical sale and purchase transactions;
determine the securities trading fee for each of the plurality of parties to the sale and purchase transaction for the sale and purchase transaction based upon the valuation variable and the time variable corresponding to each of the plurality of historical sale and purchase transactions; and
generate an output based upon the securities trading fees.

5. The system of claim 1, wherein the one or more computerized processors being configured to determine the securities trading fees for the party for the sale and purchase transaction includes the one or more computerized processors being configured to determine a trading score for the party.

6. The system of claim 5, wherein the one or more computerized processors being configured to determine the trading score for the party includes the one or more computerized processors being configured to assess the valuation value and penalize the score based upon the valuation value indicating high value trades in excess of a threshold valuation.

7. The system of claim 5, wherein the one or more computerized processors being configured to determine the trading score for the party includes the one or more computerized processors being configured to assess the time value and penalize the score based upon the time value indicating a time between trades being less than a threshold time.

8. The system of claim 5, wherein the one or more computerized processors being configured to determine the trading score includes a time decay effect lessening an effect upon the score of older portions of the trading history.

9. The system of claim 5, wherein the one or more computerized processors being configured to determine the trading score includes the one or more computerized processors being configured to penalize the score based upon the trading history indicating an undesirable trading pattern indicating market manipulation.

10. The system of claim 9, wherein the one or more computerized processors being configured to penalize the score based upon the trading history indicating an undesirable trading pattern indicating market manipulation includes the one or more computerized processors being configured to penalize the score based upon the trading history indicating a short squeeze or spoofing.

11. The system of claim 9, wherein the one or more computerized processors being configured to generate the output based upon the securities trading fee includes the one or more computerized processors being configured to publish the securities trading fee to the party and prompt the party to approve the sale and purchase transaction.

12. The system of claim 9, wherein the one or more computerized processors is further configured to execute the sale and purchase transaction based upon approval of the party.

13. A system for determining a securities trading fee for a sale and purchase transaction, comprising:
one or more computerized processors configured to:
acquire a first trading history for a buyer of the sale and purchase transaction, wherein the first trading history describes a plurality of historical sale and purchase transactions in which the buyer participated;
identify for the buyer of the sale and purchase transaction a valuation variable for each of the plurality of historical sale and purchase transactions in which the buyer participated;
identify for the buyer of the sale and purchase transaction a time variable for each of the plurality of historical sale and purchase transactions in which the buyer participated;
acquire a second trading history for a seller of the sale and purchase transaction, wherein the second trading history describes a plurality of historical sale and purchase transactions in which the seller participated;
identify for the seller of the sale and purchase transaction a valuation variable for each of the plurality of historical sale and purchase transactions in which the seller participated;
identify for the seller of the sale and purchase transaction a time variable for each of the plurality of historical sale and purchase transactions in which the seller participated;
assess an impact to the buyer of a presently desired transaction;
assess an impact to the seller of the presently desired transaction;
determine the securities trading fee for the buyer to the sale and purchase transaction for the sale and purchase transaction based upon the valuation variable and the time variable corresponding to each of the plurality of historical sale and purchase transactions in which the buyer participated and the assessed impact to the buyer;
determine the securities trading fee for the seller to the sale and purchase transaction for the sale and purchase transaction based upon the valuation variable and the time variable corresponding to each of the plurality of historical sale and purchase transactions in which the seller participated and the assessed impact to the seller; and
generate an output based upon the securities trading fees.

14. A method for determining a securities trading fee for a sale and purchase transaction, comprising:
within one or more computerized processors:
acquiring a first trading history for a buyer of the sale and purchase transaction, wherein the first trading history describes a plurality of historical sale and purchase transactions in which the buyer participated;
identifying for the buyer of the sale and purchase transaction a valuation variable for each of the plurality of historical sale and purchase transactions in which the buyer participated;
identifying for the buyer of the sale and purchase transaction a time variable for each of the plurality of historical sale and purchase transactions in which the buyer participated;
acquiring a second trading history for a seller of the sale and purchase transaction, wherein the second trading history describes a plurality of historical sale and purchase transactions in which the seller participated;
identifying for the seller of the sale and purchase transaction a valuation variable for each of the plurality of historical sale and purchase transactions in which the seller participated;
identifying for the seller of the sale and purchase transaction a time variable for each of the plurality of historical sale and purchase transactions in which the seller participated;
determining the securities trading fee for the buyer to the sale and purchase transaction for the sale and purchase transaction based upon the valuation variable and the time variable corresponding to each of the plurality of historical sale and purchase transactions in which the buyer participated;
determining the securities trading fee for the seller to the sale and purchase transaction for the sale and purchase transaction based upon the valuation variable and the time variable corresponding to each of the plurality of historical sale and purchase transactions in which the seller participated; and
generating an output based upon the securities trading fees.

15. The method of claim 14, wherein generating the output includes charging the securities trading fees to the buyer and to the seller.

16. The method of claim 15, wherein generating the output further includes executing the sale and purchase transaction.

17. The method of claim 14, wherein generating the output includes discharging funds deposited as execution of the sale and purchase transaction.

18. The method of claim 14, wherein generating the output includes publishing accumulated statistics for a plurality of sale and purchase transactions to validate equitable purposes of the method.
